(19) United States
(12) Patent Application Publication
(10) Pub. No.: US 2010/0027478 A1
(43) Pub. Date: Feb. 4, 2010

(54) METHOD FOR CHANNEL SELECTION IN A MULTI-HOP WIRELESS MESH NETWORK

(75) Inventors: Yuechun Chu, Winter Springs, FL (US); Heyun Zheng, Sichuan (CN)

Correspondence Address: MOTOROLA, INC, 1303 EAST ALGONQUIN ROAD, IL01/3RD, SCHAUMBURG, IL, 60196, US

(73) Assignee: Motorola, Inc., Schaumburg, IL (US)

(21) Appl. No.: 12/183,636

(22) Filed: Jul. 31, 2008

(51) Int. Cl. H04Q 7/00

(52) U.S. Cl. 370/329

(57) ABSTRACT

Disclosed are methods including a new optimization criterion, Maximum Mesh Coverage (MMC) for a channel selection process during the formation of ad hoc networks. By using MMC, the intelligent access point (IAP) will select a channel to connect as many mesh nodes as possible in addition to meeting the interference minimization requirement. During mesh formation, the channel interference information for a node is first scanned by the node and then broadcast in its available channels. An iteration procedure for meshing network formation allows the IAP to gradually obtain the global channel interference information and broadcast the same so that a maximum number of n-hop nodes communicate on the same frequency channel. If a channel change is required to accommodate the channel interference status of candidate nodes, a channel change message will be broadcast to better achieve the large coverage advantage of a multi-hop configuration.

### FIELD OF THE DISCLOSURE

The present invention relates generally to multi-hop wireless mesh networks and more particularly to channel selection for communication throughout a multi-hop wireless mesh network.

### BACKGROUND

Ad hoc networks are self-forming networks which can operate in the absence of any fixed infrastructure, and in some cases the ad hoc network is formed entirely of mobile nodes. An ad hoc network typically includes a number of geographically-distributed, potentially mobile units, sometimes referred to as “nodes,” which are wirelessly connected to each other by one or more links (e.g., radio frequency communication channels). The nodes can communicate with each other over a wireless media without the support of an infrastructure-based or wired network.

A wireless mesh network is a collection of wireless nodes or devices organized in a decentralized manner to provide range extension by allowing nodes to be reached across multiple hops. In a multi-hop network, communication packets sent by a source node can be relayed through one or more intermediary nodes before reaching a destination node. A large network can be realized using intelligent access points (IAP) which provide wireless nodes with access to a wired backhaul.

Wireless mesh networks, and in particular multi-hop networks, have gained great popularity in recent years since they offer deployment and coverage advantages. Typically, an infrastructure-based wireless mesh network includes an Intelligent Access Point (IAP), one or more Access Points (AP) and Stations (STA), those for example can be mobile communication devices. One advantage of the multi-hop configuration is that it may cover a much larger area than, for example, a conventional wireless local area network (WLAN) which is a one-hop network. A multi-hop configuration can provide communication between a number of interconnected nodes and an IAP which connects the nodes to a wired network. On the other hand, in a WLAN, an AP itself is connected to the wired network.

The IAP can operate as a gateway to a wired backhaul network. Nodes of the network connect to the IAP to gain access to the backhaul network which in turn may provide access to other networks such as, for example, the Internet. In a multi-hop configuration, an AP may be responsible for forwarding traffic for other APs so that the other APs may connect to the IAP through a multi-hop route. Moreover, an AP maybe responsible for providing data service to associated STAs. If an IAP or AP uses a transceiver with, for example, an omni-antenna for mesh connection, all mesh nodes (i.e. IAP and APs) in one mesh network need to operate on one channel to maintain their connection.

Multiple frequency channels are typically available. For example, the Institute of Electrical and Electronics Engineers, Inc (IEEE) 802.11b/g standard defines three non-overlapping channels and the IEEE 802.11a standard defines 12/13 non-overlapping channels for use by mesh networks. (For these and any IEEE standards recited herein, see: http://standards.ieee.org/getieee802/index.html or contact the IEEE at IEEE, 445 Hoes Lane, PO Box 1331, Piscataway, N.J. 08855-1331, USA.) An IAP typically executes automatic channel selection at bootup to choose a channel. Oftentimes, the channel selection is arbitrary. According to the typical automatic channel selection process, at initialization an IAP locally scans the available channels and selects a channel based on its own local scan that has minimum local interference, that is which channels are available and/or operational. The IAP may then randomly choose a channel determined from its local scan as the operational channels. Then, during the AP initialization, an AP scans all available IAPs on different channels. Once the AP chooses an IAP based on criteria such as best routing metrics towards an IAP, the AP switches to the channel of the chosen IAP in order to associate with the particular IAP.

In either the above-described IAP initialization or the AP initialization, an IAP is not privy to the interference status of other APs since it only takes into consideration its own local channel interference status. Accordingly, unless an AP can operate on the same channel as that selected by the IAP based on its own local interference status, the candidate node may not be able to join the mesh network of that particular IAP during network formation. For example, if a node experiences interference on that particular channel, it will be unable to participate in the mesh network. Interference can be caused for example by a Radar system in close proximity to the node.

Accordingly, there is a need for method for channel selection in a multi-hop wireless mesh network.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a multi-hop wireless mesh network operating in accordance with some embodiments.

FIG. 2 is a block diagram of a multi-hop wireless mesh network operating in accordance with some embodiments.

FIG. 3 is a flowchart illustrating a method of a channel selection in a multi-hop wireless mesh network in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Disclosed is a method for channel selection in a multi-hop wireless mesh network, including collecting channel interference information for one or more channels by an intelligent access point from one or more next-hop nodes, selecting a channel based on a Maximum Mesh Coverage calculated using the collected channel interference information, forming a mesh network including the intelligent access point and the one or more next-hop nodes, wherein the mesh network operates as a logical intelligent access point, determining if the logical intelligent access point has at least one other next-hop node by the logical intelligent access point repeating the collecting step and repeating the selecting, forming, and determining steps by the logical intelligent access point when the logical intelligent access point has at least one other next hop node.

The large coverage advantage of a multi-hop configuration of a network is better achieved by the ability to include more nodes, including both one-hop nodes and next-hop nodes that experience interference on a channel that could be otherwise selected by the IAP in the above-described IAP initialization scheme. That is, even though a node experiences interference on a particular channel, other channels could be operational. Were the IAP privy to the available channels of that node, a channel switch of all nodes could be possible and beneficially accommodate the node on the otherwise operational channel. That is, were the IAP privy to the operational and/or non-operational channels of candidate nodes, the IAP could select a channel that is not based on its own local channel interference status but could select a channel based on which channels are operational or interference free for as many nodes as possible to form an advantageously large mesh network. Upon network formation, more candidate nodes can be included in the network if the channel selection of the mesh network as a whole were based interference information of not only the IAP, but of candidate nodes as well. In this way, if one or more candidate nodes experience interference on certain channels and the IAP is made aware of the otherwise operational channels of the one or more candidate nodes, the IAP can select a channel that is operational or free of interference for the largest number of candidate nodes instead of selecting a channel for which one or more candidate nodes experience interference. In this way, candidate nodes that experience interference on certain channels, can use other channels that are operational and join in the mesh network.

During mesh network formation, one or more next-hop nodes scan and transmit their locally determined channel interference information to an IAP. The IAP collects channel interference information from one or more next-hop nodes. Based on a Maximum Mesh Coverage (MMC) calculated using the collected channel interference information, a channel for at least one iteration of mesh network formation is selected. In the initial step, at boot up an IAP collects information from one-hop nodes and selects a channel based on MMC. Then, IAP and one-hop nodes form a tentative network, which work as a single entity and are treated as logical IAP. In the next iteration, the logical IAP repeats the collecting, selecting and forming steps to add more nodes to the network, which in turn forms a new logical IAP. Upon repeat the selecting step a channel change could be necessary to include new nodes. The large coverage advantage of a multi-hop configuration is better achieved by accommodating the channel interference status of candidate nodes.

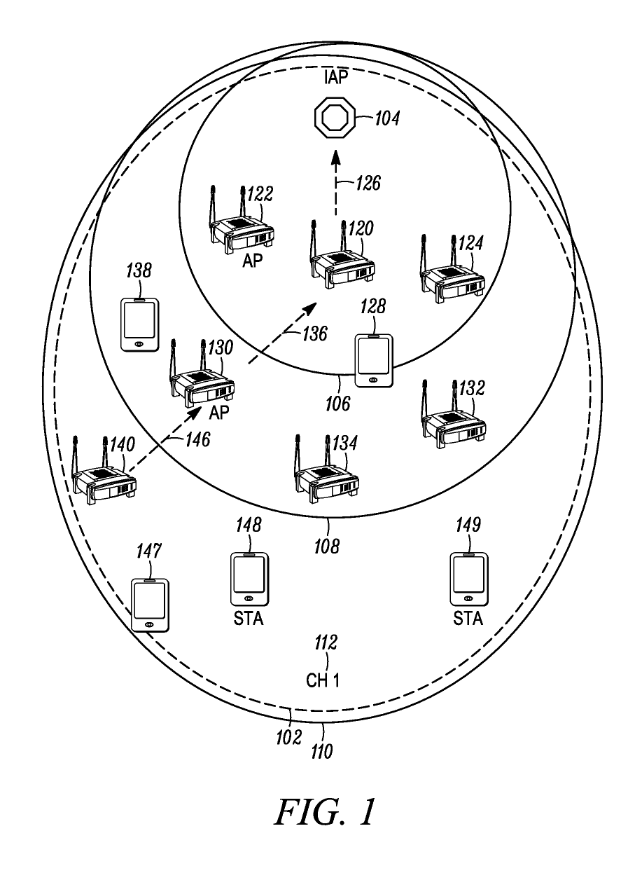

FIG. 1 is a block diagram of a multi-hop wireless mesh network operating in accordance with some embodiments. The multi-hop wireless mesh network includes an Intelligent Access Point (IAP), a plurality of access points (AP), also referred to as nodes, and a plurality of stations (STA) for example which can be mobile communication devices. FIG. 1 illustrates an iterative process in which a wireless mesh network, in iterative steps, acquires n-hop nodes. The multi-hop mesh network 102 indicated by the dotted line includes an IAP 104 which provides the gateway to a backhaul network, such as the Internet. Nodes of the network connect to the IAP to gain access to the backhaul network. Accordingly, stations therefore communicate with the nodes, which in turn communicate with the IAP 104 to access, for example, the Internet.

As mentioned, a station that is a mobile communication device which, can be implemented as a cellular telephone (also called a mobile phone). A mobile communication device represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices can be referred to as a mobile station or user equipment. Herein, wireless communication technologies can include, for example, voice communication, the capability of transferring digital data, SMS messaging, Internet access, multi-media content access and/or voice over internet protocol (VoIP).

There may be a plurality of iterative steps to form a multi-hop mesh network 102 including levels of interconnected nodes. An initial mesh network can be formed including an IAP 104 and next-hop nodes 120, 122 and 124, which together form a logical IAP 106. In a next iteration the network can be enlarged to include the logical IAP 106 and next-hop nodes 130, 132 and 134, which together form another logical IAP 108. In the next iteration the network can be further enlarged to include the logical IAP 108 and at least one next-hop node 140, which together form another logical IAP 110. While not depicted, any number of logical IAPs could be formed. As will be described in detail, an optimization criterion, Maximum Mesh Coverage (MMC) for channel selection is included in an iteration procedure as described with reference to FIG. 1 to allow global available channel interference information propagation to enable MMC based channel selection. FIG. 1 depicts that the multi-hop network 102 is eventually in communication via Channel 1 (Ch. 1) 112.

As discussed, the multi-hop wireless mesh network 102 can be formed iteratively. The arrow 126 indicates that the node 122 is a next-hop from the IAP 104. Similarly, nodes 120 and 124 are depicted as next-hop from the IAP 104. STA 128 for example could be in communication with any one of the nodes 120, 122 or 124 to gain access to the backhaul network via IAP 104. The process to obtain the particular frequency channel on which the logical IAP 106 could operate will be discussed below.

The logical IAP 108 may be formed of first-hop nodes 130, 132 and 134, from logical IAP 106, and logical IAP 106 being inclusive in logical IAP 108. The arrow 136 indicates that the node 130 is one-hop from the logical IAP 106. Similarly, nodes 132 and 134 are depicted as one-hop from the logical IAP 106. STA 138 for example could be in communication with any one of the nodes 130, 132 or 134 to gain access to the backhaul network via IAP 104. The logical IAP 108 can operate on a particular frequency channel which could be the same or different from that of intelligent IAP 106.

The logical IAP 110 could be formed of at least one first-hop node represented by a node 140, logical IAP 108 and 106 being inclusive in logical IAP 110. The arrow 146 indicates that the node 140 is one-hop from the logical IAP 108 and interconnected to IAP 104 via node 130 and node 120. STA 147, STA 148 and STA 149 for example could be in communication the node 140, which is in turn in communication with node 130, which is in turn in communication with node 120 to gain access to the backhaul network via IAP 104 of the depicted multi-hop mesh network 102. The logical IAP 110 operates on a particular frequency channel which can be the same or different from that of logical IAP 108.

It is understood that while the multi-hop mesh network 102 is graphically depicted so that the various logical IAPs are relatively symmetrical, the physical distribution of the APs relative to the IAP can be in any configuration. The graphic depiction of FIG. 1 is simplified for the purpose of clarity. Any number of APs and logical IAPs are within the scope of this discussion as well.

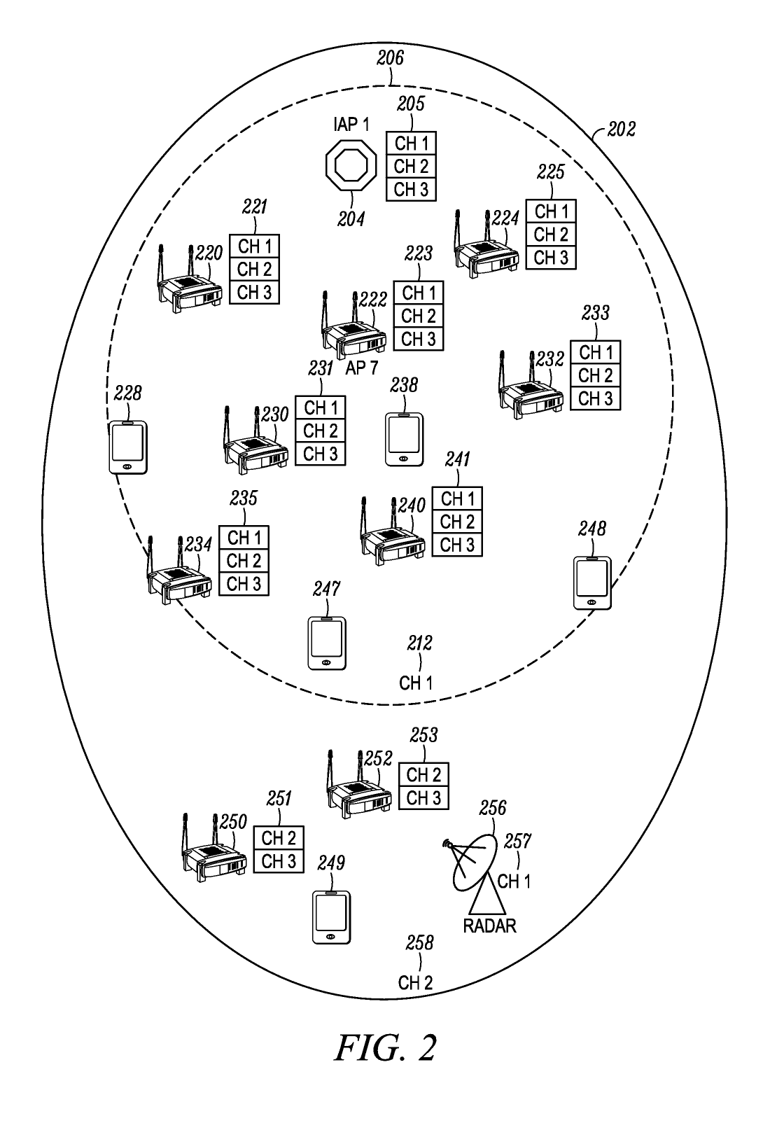

FIG. 2 is a block diagram of a multi-hop wireless mesh network operating in accordance with some embodiments. The multi-hop wireless mesh network includes an Intelligent Access Point (IAP), a plurality of access points (AP), also referred to as nodes, and a plurality of stations (STA) for example which can be mobile communication devices. FIG. 2 illustrates an iterative process in which a wireless mesh network changes the channel that is initially selected to a new channel based on interference information provided by a candidate node. A multi-hop mesh network 202 indicated by the solid line that includes an IAP 204 which provides the gateway to the backhaul network to a wired network, such as the Internet. Nodes of the network connect to the IAP to gain access to the backhaul network. Accordingly, stations can therefore communicate with the nodes, which in turn communicate with the IAP 204 to access, for example, the Internet.

As discussed above, in order to maintain connectivity, the interconnection among nodes operates in the same frequency channel. As will be described in more detail below, to minimize channel interference and foreign radio devices such as Radar systems, channel selection is determined upon mesh formation in an iterative process such as that described with reference to FIG. 1. As discussed above with reference to FIG. 1, during mesh network formation logical IAPs are formed that include their predecessor IAP. A logical IAP utilizes the same or different channel frequency than their predecessor. In one embodiment, the process can continue until there are no other next-hop nodes. It is beneficial that the important operational performance factor that the coverage area of a mesh network is maximized in accordance with the disclosed channel selection methods and devices. The more mesh nodes within a mesh network, the bigger covered area for mobile user stations.

The channel selection process includes a Maximum Mesh Coverage (MMC) criterion. Based upon the MMC channel selection process, the selected channel can connect as many mesh nodes as possible in addition to meeting an interference minimization requirement. As will be further described, the IAP 204 can choose a channel based on the global view of the channel interference information from a plurality or all wireless mesh nodes.

In FIG. 2, for simplicity an assumption is made that there are only three available channels, Ch 1, Ch 2 and Ch 3 and except for the devices shown in FIG. 2, no other device operates on these channels. The IAP 204 locally scans for available and/or operation channels 205 and in this example determines that all three channels Ch 1, Ch 2 and Ch 3 are available. In utilizing MMC for channel selection, in particular, the APs determine their local channel interference status which can include determining both operational and non-operational channels. Accordingly, channel interference status is collected among the mesh nodes in the mesh network. That is, AP 220 locally scans to determine operational and non-operational frequency channels Ch 1, Ch 2 and Ch 3 and determines that all three channels 221 are operational, that is free of interference. AP 222 locally scans to determine operational and non-operational frequency channels Ch 1, Ch 2 and Ch 3 and determines that all three channels 223 are operational, that is free of interference. AP 224 locally scans to determine operational and non-operational frequency channels Ch 1, Ch 2 and Ch 3 and determines that all three channels 225 are operational, that is free of interference. AP 230 locally scans to determine operational and non-operational frequency channels Ch 1, Ch 2 and Ch 3 and determines that all three channels 231 are operational, that is free of interference. AP 232 locally scans to determine operational and non-operational frequency channels Ch 1, Ch 2 and Ch 3 and determines that all three channels 233 are operational, that is free of interference. AP 240 locally scans to determine operational and non-operational frequency channels Ch 1, Ch 2 and Ch 3 and determines that all three channels 241 are operational, that is free of interference.

In the initialization step, when IAP 204 is powered up, it collects interference information from next-hop nodes and selects a channel based on MMC. Then, IAP 204 and the next-hop nodes form a tentative network, such being logical IAP 206 in this example. The logical IAP 206 therefore is formed of next-hop nodes 220, 222, 224, 230, 232, 234 and 240. It is understood that depending upon efficiency of information collection, the initial mesh network may not include all of the next-hop nodes. STAs 228, 238, 247 and/or 248 for example can be in communication with any one of the nodes 220, 222, 224, 230, 232, 234 and 240 to gain access to the backhaul network via IAP 204. Since in this example, all channels, Ch 1, Ch 2 and Ch 3, are operational, the IAP can determine to use any channel. The logical IAP 206 in this example chooses a particular frequency channel 212 in this example, Ch 1.

Similar to the step described immediately above, the logical IAP 206 collects information from next-hop nodes 250 and 252. In this way, the logical intelligent access point 206 can determine if it has at least one other next-hop node by the logical intelligent access point 206 repeating the collecting step. In this example, the collecting step of channel interference information may determine that not all channels, Ch 1, Ch 2 and Ch 3 are interference free. Depicted in FIG. 2 is RADAR 256 that operates on Ch 1. Since the logical IAP 206 has collected interference information from nodes 250 and 252, it determines that there is interference in Ch 1. The selecting step can be selecting a channel based on a MMC using the collected channel interference information that Ch 1 is unavailable. To bring in nodes 250 and 252 into the mesh network 202, the logical IAP 206, in this example, selects a different channel 258, such as Channel 2. A broadcast of a change channel signal by the IAP 204 is provided so that nodes 220, 222, 224, 230, 232, 234 and 240 also change to Ch 2. Once IAP 204 and nodes 250 and 252 are operating in the same frequency channel, their connectivity is maintained, enlarging the coverage of the mesh network. Accordingly, nodes 250 and 252 become part of the multi-hop wireless mesh network 202.

As mentioned above, the steps of selecting, forming, and determining steps by a logical IAP, such as logical IAP 206 when the logical IAP has at least one other next hop node is repeated to include as many mesh nodes as possible. Moreover, the selecting step includes selecting a channel which can accommodate a maximum number of mesh nodes, determined in accordance with a MMC. In the example of FIG. 2, a 2-hop mesh network is formed. At a final step, an n-hop mesh network is formed.

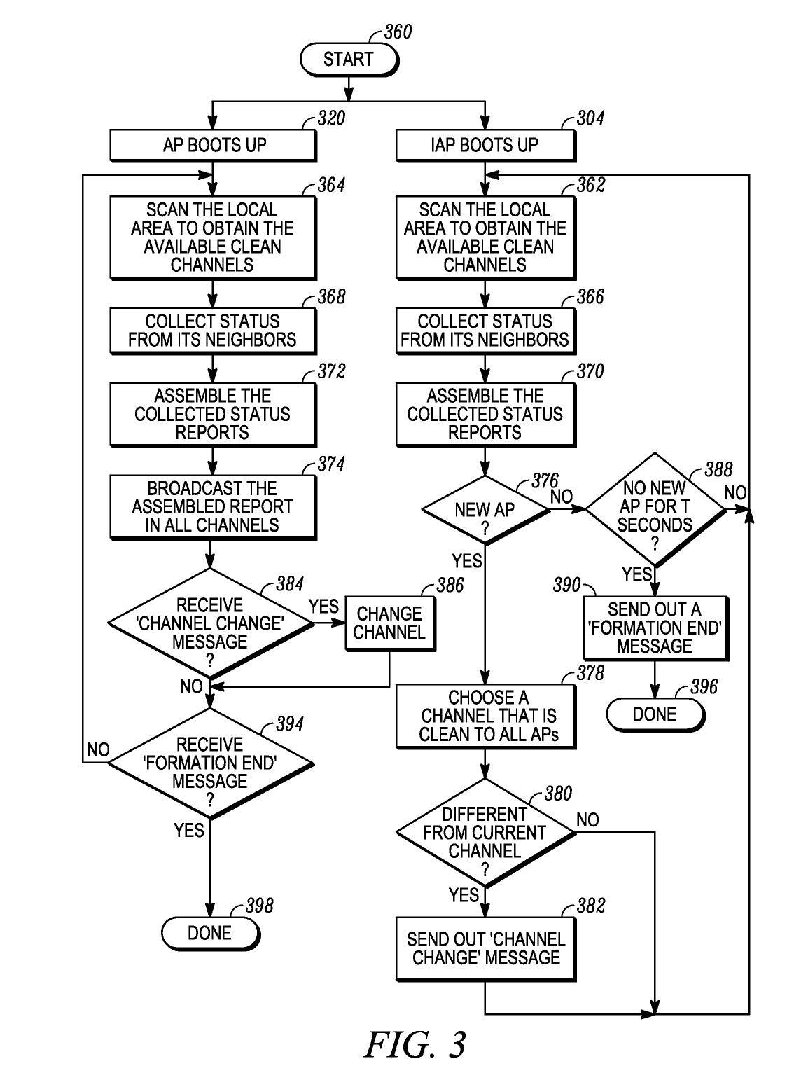

FIG. 3 is a flowchart depicting an embodiment of the method of a channel selection in a multi-hop wireless mesh network. Upon the initialization or start 360, an IAP 104 (see FIG. 1) will boot up 304 and perform a local scanning 362 to obtain locally available clean channels. AP or node 320 will boot up and perform a local scanning 364 to obtain their locally available clean channels. The scanning process includes the steps of switching to a channel and assessing the interference level on that channel. Such a scanning process is repeated for every available channel. The IAP 104 can schedule a scanning process at its own convenience and can broadcast a request that the nodes of the network do the same. As illustrated in FIG. 1, the IAP 104 collects channel interference information 366 from its neighbors such as APs 122 and 124. An individual AP, such as AP 120 collects channel interference information 368 from its neighbors, for example, APs 122 and 124, as well.

Upon collecting the channel interference information an IAP 104 (see FIG. 1) summarizes a report 370 to determine the channel status of the APs. Also, upon collecting the channel interference information, an AP 120 can summarize the report 372 to determine channel availability status of the APs. In either case, where an AP 120 has scanned and determined its own local interference information and/or collected the interference information of other APs such as APs 122 and 124, the AP 120 broadcasts 374 its own local the interference information or an assembled report. In either event, the AP 120 can broadcast interference information in all channels, including operations and non-operational channels.

If a new AP is found, IAP 204 (see FIG. 2), will choose a channel to accommodate as many as possible or all of the APs, including the new AP. For example, in FIG. 2, a new AP 250 was found 376. The IAP 204 may have collected interference information from AP 250 through iterative steps to learn that Ch 1 is not available for AP 250. That is, Ch 2 and Ch 3 are available for AP 250. Accordingly, the IAP 204 needs to select a new channel so that AP 250 may be part of the multi-hop mesh network. For example, the IAP 204 can choose 378 Ch 2 which is a channel that is clean to most or all APs in the network. If it is determined that Ch 2 is different 380 from the current channel of the logical IAP 206 which utilizes Ch 1, the IAP 204 sends out a “channel change” message 382.

The APs of the logical IAP 206 may receive the channel change message 384 and then change their channel 386, for example to Ch 2 as illustrated in FIG. 2. If there is no change channel message 384, the status quo may remain intact. If no new AP is found 388, the IAP 204 may repeat the whole process until a time out condition is met, such as a predetermined period of time passes with no new AP. Once the time out condition is met, the IAP 204 may send out a “formation end” message 390 to the APs in the network to end the network formation process 392. When an AP, such as APs 250 and 252 receive a “formation end” message 394 from IAP 204, the formation process may end 398.

As mentioned, the collecting steps 366 and/or 368 can be performed periodically to obtain a list of clean channels in the neighborhood of an intelligent access point such as IAP 204 (see FIG. 2) or an AP such as APs 250 and 252. By periodically scanning one or more available channels for an interference status, thereby obtaining a list of clean channels in a neighborhood of the next hop node, combining each local channel interference status and each associated channel interference status, and broadcasting the combined interference status in all available channels, each recipient AP as well as an IAP can receive one or more channel interference status broadcast by one or more neighboring nodes in the available channels, to determine if there is a need to change the selected channel.

The large coverage advantage of a multi-hop configuration is better achieved by the ability to include one or more nodes, including both one-hop nodes and next-hop nodes that may experience interference on a channel that is otherwise selected by the IAP in an IAP initialization scheme. That is, even though a node experiences interference on a particular channel, other channels can be operational. As described above, were the IAP privy to the available channels of that node, a channel switch of all nodes is possible and beneficially accommodate the node on the otherwise operational channel. During mesh network formation, one or more next-hop nodes transmit their locally determined channel interference information to the IAP. That is, each node scans channels locally to determine which channels are operational and which channels are not operational. Channel interference information can include one or both operational channels and/or non-operational channels. In this way, channel interference information locally obtained by a node is transmitted to the IAP.

The IAP collects channel interference information from one or more next-hop nodes. Based on a Maximum Mesh Coverage calculated using the collected channel interference information, a channel for at least one iteration of a mesh formation is selected. The mesh network including the IAP and the one or more next-hop nodes operates as a logical IAP. Upon establishing the logical IAP, a determination is made if the logical IAP has at least one other next-hop node by repeating the collecting step. Accordingly, the next-hop nodes will transmit the available channel information from one or more next-hop nodes. The logical IAP will collect the available channel information from the next-hop nodes. If the logical IAP can accommodate the operational channels of the one or more next-hop nodes, as well as at least a plurality of the nodes included in the logical IAP, the next iteration of the mesh formation includes one or more new next-hop nodes. A channel change could be necessary to include the most nodes since the large coverage advantage of a multi-hop configuration is better achieved by the ability to include more next-hop nodes. The repeating the selecting, forming, and determining steps by the logical IAP allows the process to continue until there are no other next-hop nodes added to the mesh network during mesh formation. In this way, large coverage advantage of a multi-hop configuration is better achieved.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for channel selection in a multi-hop wireless mesh network comprising:
collecting channel interference information for one or more channels by an intelligent access point from one or more next-hop nodes;
selecting a channel based on a Maximum Mesh Coverage calculated using the collected channel interference information;
forming a mesh network including the intelligent access point and the one or more next-hop nodes, wherein the mesh network operates as a logical intelligent access point;
determining if the logical intelligent access point has at least one other next-hop node by the logical intelligent access point repeating the collecting step; and
repeating the selecting, forming, and determining steps by the logical intelligent access point when the logical intelligent access point has at least one other next hop node.

2. The method of claim 1, wherein the Maximum Mesh Coverage establishes a requirement for a network to include as many mesh nodes as possible, and further wherein the selecting step includes selecting the channel which can accommodate a maximum number of mesh nodes.

3. The method of claim 1, further comprising prior to the collecting step:
periodically scanning one or more available channels for an interference status by the intelligent access point, thereby obtaining a list of clean channels in a neighborhood of the intelligent access point.

4. The method of claim 1, wherein the collecting step comprises:
collecting a channel interference status broadcast by each of the next hop nodes in one or more available channels.

5. The method of claim 1, further comprising prior to the collecting step:
at each of the next hop nodes:
periodically scanning one or more available channels for an interference status, thereby obtaining a list of clean channels in a neighborhood of the next hop node;
combining each local channel interference status and each associated channel interference status;
broadcasting the combined interference status in all available channels; and
collecting each channel interference status broadcast by one or more neighboring nodes in the available channels.

6. The method of claim 5, wherein the broadcasting step includes broadcasting on one or more non-operating channels.

7. The method of claim 6, wherein each of the one or more non-operating channels comprise channels including interference.

8. The method of claim 1, wherein the forming step further comprises:
at each of the next hop nodes included in the logical intelligent access point:
combining each local channel interference status and each associated channel interference status;
broadcasting the combined interference status in all available channels; and
collecting each channel interference status broadcast by one or more neighboring nodes in the available channels.

9. The method of claim 1, wherein each of the next hop nodes comprises at least one mesh node.

10. The method of claim 1, wherein the selected channel comprises a meshing link operation channel.

11. The method of claim 1, further comprising:
communicating a formation end message from the intelligent access point when it is determined that there is not at least one other next-hop node.

12. The method of claim 11, wherein the determining there is not at least one other next-hop node comprises:
determining that no channel interference information is received within a predetermined period of time.

13. A method for channel selection in a wireless mesh network comprising:
scanning locally by a plurality of nodes that are next-hop from an intelligent access point to determine local channel interference information of the plurality of mesh nodes;
broadcasting by the plurality of nodes the local channel interference information;
collecting channel interference information for one or more channels by the intelligent access point from one or more nodes;
selecting a channel based on a Maximum Mesh Coverage calculated using the collected channel interference information; and
forming a wireless mesh network including the intelligent access point and one or nodes.

15. The method of claim 14, further comprising:
determining if the logical intelligent access point has at least one other next-hop node by the intelligent access point repeating the collecting step; and
repeating the selecting, forming, and determining steps by the intelligent access point when the logical intelligent access point has at least one other next hop node.

16. The method of claim 14, further comprising:
receiving from at least one other next-hop node local interference information;
selecting a different channel that accommodates the mesh network and the at least one other next-hop node.

17. The method of claim 16, further comprising:
broadcasting a channel change signal announcing the different channel.

18. A method for channel selection in a wireless mesh network comprising:
scanning locally by a plurality of nodes to determine local channel interference information of the plurality of nodes;
broadcasting by the plurality of nodes the local channel interference information;
collecting channel interference information for one or more channels by at least one of the plurality of nodes;
selecting a channel based on a Maximum Mesh Coverage calculated using the collected channel interference information; and
forming a wireless mesh network including an intelligent access point and the one or more of the plurality of nodes.

19. The method of claim 18, further comprising:
receiving from at least one other node local interference information;
selecting a different channel that accommodates the wireless mesh network and the at least one other node.

20. The method of claim 19, further comprising:
broadcasting a channel change signal announcing the different channel.
